(19) United States
(12) Patent Application Publication
(10) Pub. No.: US 2004/0088560 A1
(43) Pub. Date: May 6, 2004

(54) Secure system access

(76) Inventor: David Hilton Danks, Victoria (AU)

Correspondence Address: GREER, BURNS & CRAIN, 300 S WACKER DR, 25TH FLOOR, CHICAGO, IL, 60606, US

(21) Appl. No.: 10/258,060

(22) PCT Filed: Apr. 19, 2001
(86) PCT No.: PCT/AU01/00451

(51) Int. Cl. H04L 9/32

(52) U.S. Cl. 713/200

(57) ABSTRACT

A method of managing access to secure resources (4-9), the method including: providing an schema of permission rights in respect of secure resources; and, delegating to one or more users an ability to delegate (32) a profile (31) of selected permission rights in respect of one or more secure resources.

The invention relates to system access, and relates particularly though not exclusively to the management of secure environments for e-commerce systems.

The Internet, and more particularly the World Wide Web, has created new opportunities for conducting commercial transactions electronically. In this respect, electronic commerce between businesses (B2B e-commerce) is expected to become ever more pervasive. Accordingly, the ability of vendors to manage the process of identifying users and granting those users access to a vendor's Web site is increasingly problematic. Without an adequate system, a vendor cannot appropriately control who is permitted access to its systems. This risk exposure can potentially result in inappropriate system usage.

Existing access methods allow the user to access their vendor's secure Web site or network and conduct business electronically (such as over the Internet) through network to network connections. A user attempting to access a particular site for the purpose of a transaction must have corresponding software installed on their computer. An initial set up procedure is required for each new user of the software before they are granted permission to access the vendor's network.

This technique is relatively labour intensive. As a result, many of the efficiencies that might otherwise be achieved as a result of doing business electronically can be negated, due in large part to the inconvenience associated with system management.

Another approach is to link up the computer networks of two parties to facilitate e-commerce transactions. This can also be a costly and time-consuming practice, as external consultants are generally needed to facilitate such a connection, and significant costs are incurred from the increased labour and the need to purchase new software and hardware. Such methods are also unsuitable for B2C e-commerce due to the costs and expertise required. This approach also poses significant security risks for both parties in the event of one end of the system becoming compromised, or the business relationship between the two parties becoming hostile. The ability of one party to cause damage to the other's systems is a tangible risk exposure for both parties.

In short, current methods are generally deficient as they involve a reasonably high amount of negotiation between parties, with consequent costs. Accordingly, it would be desirable to address these and other problems associated with existing systems and techniques relating to the administration of permission rights.

The Applicant has recognised that access to secure resources can be advantageously administered by allowing for the delegation of permission rights to one or more users who, in turn, are also able to delegate permission rights to other users. It is recognised that decentralised administration of permission rights can be advantageously combined with a centralised administration of the execution of those rights.

One aspect of the invention provides a method of managing access to secure resources, the method including:

providing a schema of rights in respect of secure resources; and,

delegating to one or more users an ability to delegate a profile of selected rights in respect of one or more individual secure resources.

Each of said profiles of rights may be centrally maintained in a central server. Moreover, one or more of the secure resources may be hosted remotely from the central server. Each of the profiles of rights may constitute one of the secure resources. In this way, access to the rights granted or delegated to users may be protected in the same manner as are all other secure resources.

A plurality of the secure resources may be hosted in, and individually accessible within, a same server.

The rights may include permission rights in respect of the one or more secure resources. Preferably, the schema of permission rights is a logical arrangement of different permission rights that have an implied hierarchical order. Preferably, the schema is extendable to allow the grant of permissions in a relation to the secure resources. Preferably, the secure resources are either information sources or applications.

The rights may also include delegation rights in respect of the one or more secure resources. At least a first of the users may be able to delegate to another user a profile of selected permission rights which is less than or equal to the permission rights held by the first user. In another embodiment, the first user may not hold any permission rights, but only delegation rights. The first user may therefore be able to delegate to another user a profile of selected permission rights in respect of one or more secure resources to which the first user does not have access.

Preferably, said central server grants or denies requests made by users in respect of said secure resources. Preferably, activities of users are centrally audited and tracked in the central server: Preferably, requests to the central server are referred by servers that receive requests from remote users.

Preferably, each of said profiles of permission rights represent a profile in respect of a particular set of one or more secure resources.

Preferably, said permission rights govern access to generally restricted information, or use of generally restricted functionality. Preferably, said secure resources are information-based or functionality-based resources, access to which is generally restricted subject to verification of access rights is respect of said resources.

Preferably, there is for each user and each secure resource an associated access right. That is, there is for each secure resource a set of access rights associated with respective users.

The Applicant has recognised that a neutral provider can advantageously act as a central hub for the administration of access rights to sensitive information stored on the servers of various organisations.

Another aspect of the invention provides a method of allowing secure access to a remote system via a network, the method including:

(a) storing in a central server a database of permission rights for a plurality of secure resources stored in one or more remote servers;

(b) receiving a request for access to one of said respective secure resources from said plurality of remote servers;

(c) establishing the identity of a user making said access request;

(d) determining whether the user has permission rights which are sufficient to allow the user to access said one secure resource; and

(e) approving or declining said access request if the permission rights of the user are or are not sufficient to allow the user to access said one secure resource.

Preferably, said request is made to one of said remote servers and is redirected from that remote server to said central server.

A further aspect of the invention provides a method of allowing secure access to a remote system via a network, the method including:

(a) receiving a request for access to a secure resource;

(b) establishing the identity of a user making said access request;

(c) determining whether the user has permission rights which are sufficient to allow the user to access the secure resource; and

(d) approving or declining said access request if the permission rights of the user are or are not sufficient to allow the user to access the secure resource;

wherein the secure resource is stored at a remote server, and requests for access to the secure resource are received at the remote server and redirected to a central server.

Preferably, upon approval of the access request, a second remote server directs the access request to a first remote server, and the first remote server responds to the user.

Preferably, establishing the identity of the user involves the use of identification codes such as, for example, digital certificates. Preferably the digital certifications use public key cryptography techniques. Preferably, one or more users with appropriate permission rights can issue their identification codes for other users. Preferably, those one or more users can specify the permission rights enjoyed by the other users for whom they issue identification codes.

Preferably, the secure resources are formatted in a manner specific to the user making the access request.

The described methods can be used to facilitate electronic commerce transactions, by allowing organisations to administer and establish their own hierarchy of permission rights for a number of users. Preferably, a software tool or wizard is provided for allowing the organisation to develop and manage these permission rights.

Preferably, users can be delegated the capability to issue digital identification certificates, including Identrus certificates, to other users. Preferably, the secure server is capable of operating at a remote site and using digital certificates stored on a smart card to verify the permission rights of a third party.

In particular embodiments, it is preferred that a software application or component (such as, for example, a Java applet) can be downloaded onto a user's computer for the purpose of encoding a smart card with a public key and a private key. Permission rights are managed by an administrator with the appropriate permission level to grant appropriate access rights to users' smart cards.

The following description refers in more detail to the various features of the present invention. To facilitate an understanding of the invention, reference is made in the description to the accompanying drawings where the invention is illustrated in a preferred, but not limiting, embodiment.

In the drawings:

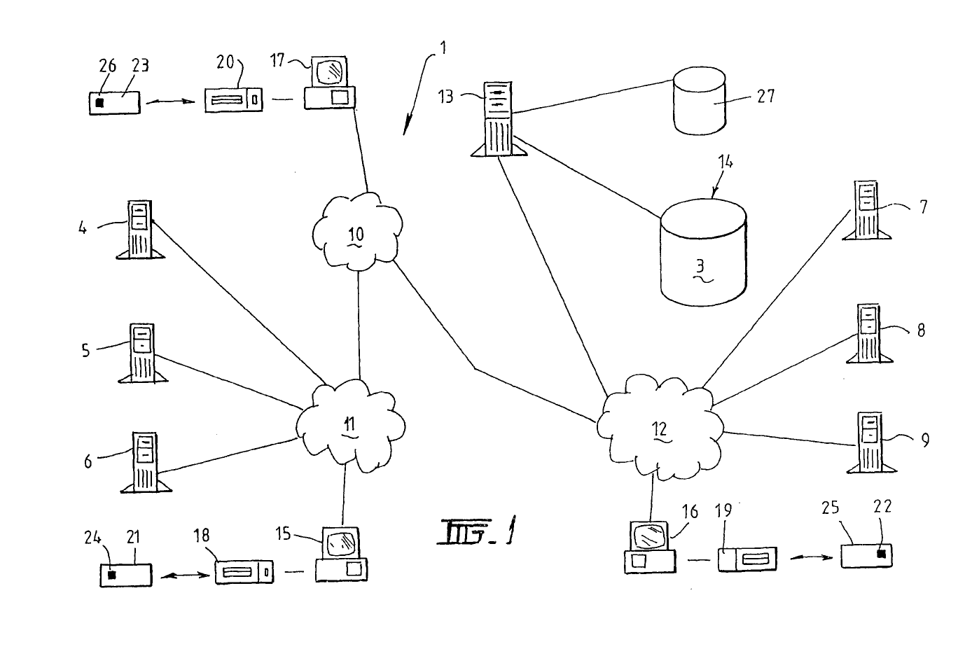

FIG. 1 is a schematic diagram of a system implementing the functionality of an embodiment of the invention;

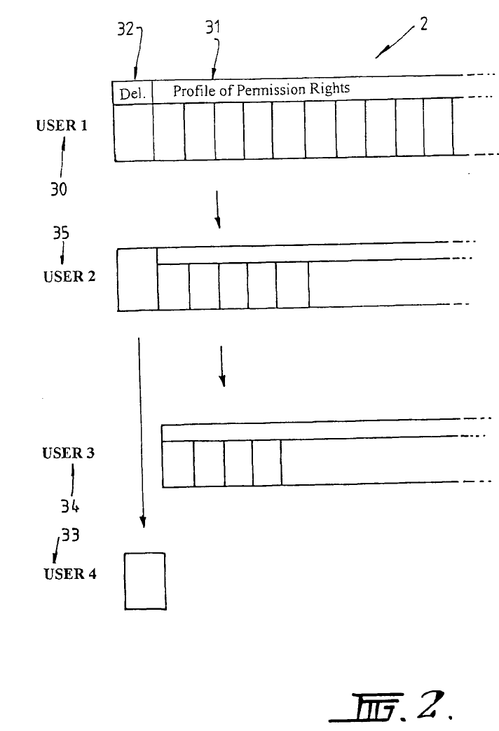

FIG. 2 is a schematic diagram illustrating hierarchically ordered schemas of permission rights administered in the system of FIG. 1; and

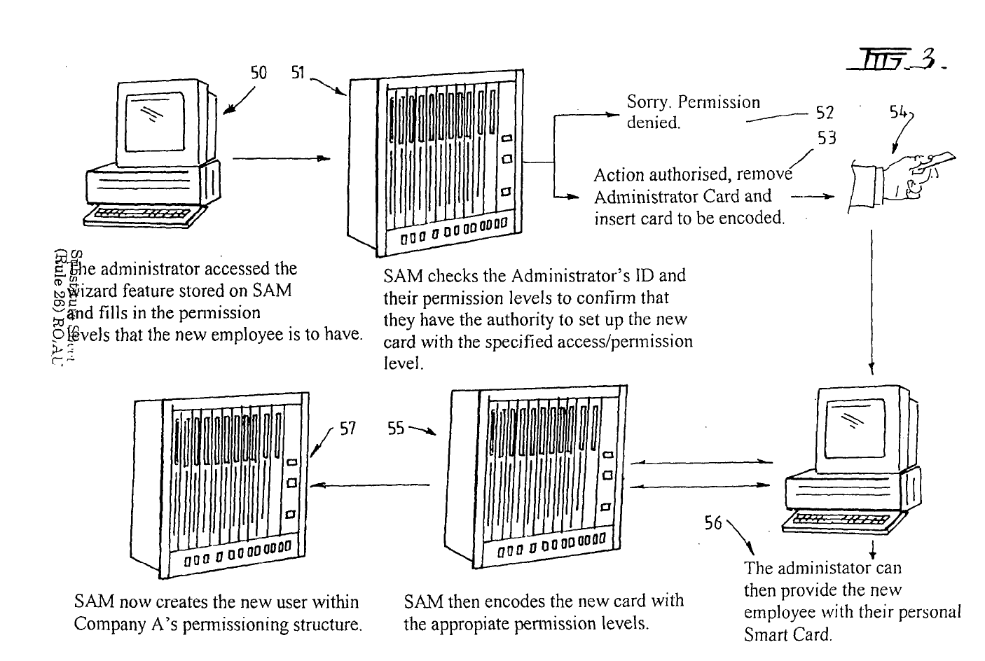

FIGS. 3 to 5 ate flow diagrams illustrating the operation of various functionality of the system of FIG. 1.

Referring now to the drawings, a system 1 is provided in which a schema 2 of permission rights 3 is established to administer access to secure resources 4 to 9, such as particular resources (eg URLs) accessible from a computer network 10 to 12, and to which access is generally restricted.

The system 1 includes a central server 13 and a database 14 in which is stored, for each user, a profile of permission rights in relation to particular secure resources. These permission rights may be, for example, read/write/execute, or add/delete/modify/purchase or any other schema of permission rights that is appropriate. In this embodiment, the schema of permission rights is fully extensive and can be adapted as required in relation to specific secure resources. For example, when a secure application is provided, various application-specific actions can be defined, and corresponding permission rights established. As a result, it is possible to determine the level and type of access a user has to any of those application-specific actions.

When a new user is created, that user 30 is provided the ability to create a further new user having a profile of permission rights that is at least equal to the profile of the creating user. Accordingly, new users are typically delegated:

(a) a profile 31 of permission rights in relation to the secure resources, as well as

(b) the ability to delegate 32 a profile of permission rights in relation to those secure resources.

In some cases, an administrative user 33 will only be delegated the ability to delegate profiles of permission rights to other users, without any or only minimal permission rights of their own. In other cases, a particular user 34 will only be granted a profile of permission rights without the ability to delegate profiles to other users.

The system 1 is intended to be used by organisations to allow any appropriate networked computing device to be used to add and delete users, and modify their permission and access/restriction levels and any other relevant criteria.

The system 1 allows, authorised users, both internal and external to a particular organisation, to access secure resources or applications remotely from any computer or other access device, such as the terminals referenced 15 to 17 (for example, personal digital assistant). It is intended that each such computing device 15 to 17 is equipped with a smart card peripheral device 18 to 20 that is able to read and write information from and to a smart card 21 to 23. The smart card stores a private key and public key pair 24 to 26 for identification of the respective smart card user. Preferably the system 1 uses digital certificates such as Identrus certificates, to authenticate users.

The computing device 15 to 17 can be positioned in any location that provides satisfactory network access. Accordingly, the computing device can be remote from the remaining infrastructure of the system, allowing for remote distribution of the system. Computing devices using the system desirably have a smart card device for use with implementations which store certificates on smart cards.

The profiles of permission rights represented in FIG. 2 are organised on an application-by-application basis. Permission rights are granted on the basis of establishing a rule or “policy” for a particular action. Permission is only granted if a user has the appropriate attributes specified by the policy. If the user's permission profile does have appropriate attributes, header variables are passed to the application. These header variables contain name/value pairs corresponding with the given user. This header variable information is used to build/customise the user interface that is presented to that user.

A policy for a given application specifies what types of users (ie profiles of permission rights having particular attributes) can perform specified actions. Additionally, further information can be passed to the application, when and as required, to enable it to restrict the user's activity for any reason.

It should be noted that the attribute types such as view, maintain, drawdown, roll-over etc are all controlled by the application. The system's role is to match the user with these attributes. The system does not process a user's attributes. The system merely passes information to particular applications specifying the user, and the permissions that user has. This may be, for example, viewing and drawdown only.

To provide a further explanation of the system, a particular example is now described. Initially, a user ID and password combination (or, alternatively, a digital certificate) is stored on a hard drive of a particular computer or on a smart card 21 to 23. This forms the basis for identification. The system 1, however, is not implementation specific—various identification techniques can be incorporated into the system. Management of relationships and their permissions can be done from any computer as the smart card carries the digital certificate that provides the ID to the system, provided that the card has sufficient authority to perform the action. A company (ABC Pty Ltd) contacts the system provider (Central Authority) for the purpose of implementing the system for ABC Pty Ltd's Web site. The Central Authority identifies the user, possibly using the system to identify ABC Pty Ltd through an Identrus certificate that ABC Pty Ltd sends to the Central Authority. All the security and access to the company's application is controlled and stored remotely on the Central Authority's server, including audit and non-repudiation functions.

ABC Pty Ltd then logs onto an online application form which is itself protected by the system. This application form allows ABC Pty Ltd access to the system. This process can occur electronically, as indicated in FIG. 3. Accordingly, at step 50, the administrator access a wizard feature accessible from the central server 13 and fills in the position levels that a new employee is to have. At step 51, the central server 13 checks the administrator's ID and their permission levels to confirm that they have authority to set up the new smart card with the specified access/permission levels. Permission is subsequently either denied at step 52 or, at step 53, the action is authorised. The administrator card is subsequently removed and the new employee smart card required to be encoded is inserted in the corresponding smart card reader at step 54. At step 55, the central server 13 provides data to the remote user terminal in question to enable the encoding of the new smart cart with the appropriate permission levels. At step 56, the administrator is then able to provide the new employee with their personal smart card. At step 57, the central server 13 then creates a new user within the particular company permissioning structure maintained in the database 14.

ABC Pty Ltd takes the system to their developers, who install the system to the front end of ABC Pty Ltd's Web system. During this process, the URL hierarchy, the database structure, application administrators, information regarding which URLs are protected as a secure resource and the business rules within the URLs, are loaded onto the database through one or more software “wizards” 27 or other tools.

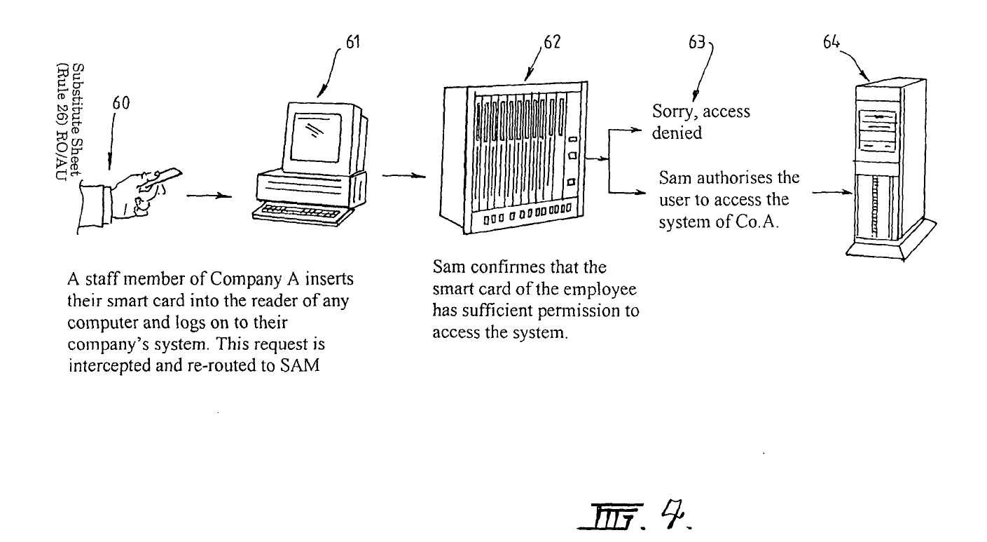

The administrator (possibly the departmental heads) will build further screens for the users and set up the users with unique profiles of permission rights using other wizards. The users may be staff, or external customers. Each of the users are provided with a smart card (or a user ID and password combination) that will enable them to access certain restricted URLs of ABC Pty Ltd applications. Particular applications will allow certain users to create new profiles, and corresponding cards. The process of a user gaining access to secure resources is indicated in FIG. 4. A user logs onto ABC Pty Ltd's computer system. Requests for secure resources are intercepted at step 61 and re-routed through the system. The system 13 determines at step 62 whether the user has sufficient and appropriate permission rights to access the secure resources. Depending on the outcome, the request is either denied at step 63 or authorised at step 64.

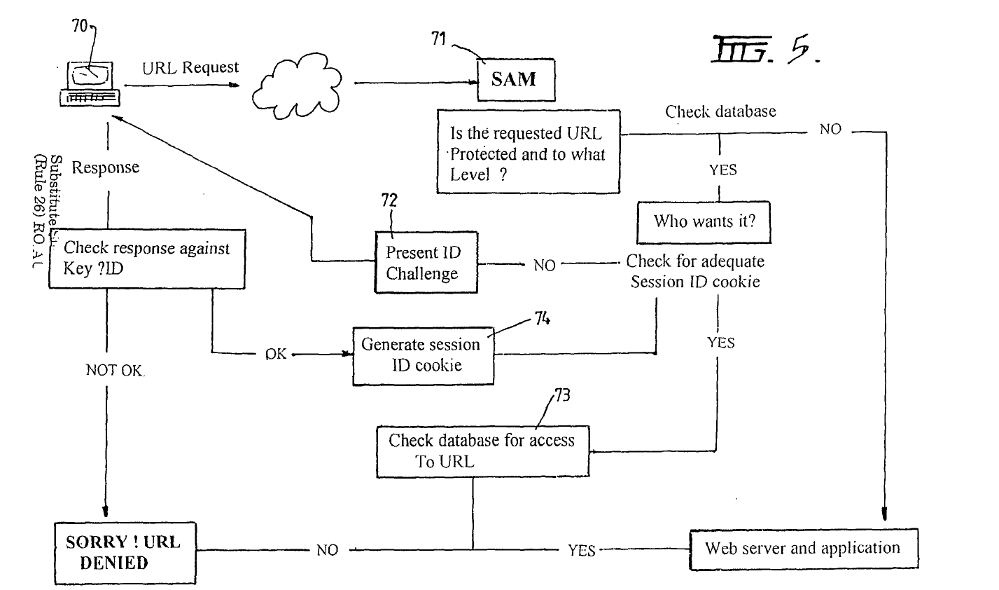

As shown in FIG. 5, ABC Pty Ltd's customer (XYZ Pty Ltd) can take a smart card, and log onto ABC Pty Ltd's Web site at step 70 from any computer, irrespective of location. If XYZ Pty Ltd try to access one of ABC Pty Ltd's restricted URLs, the system intercepts the request at step 71, challenges the user's ID at step 72, and check it off against the profile of permission rights stored in the system database for that user at step 73.

The Central Authority's server 13 completes the risk management activities at a site remote from those of the sites of remotely hosted secure resources 4 to 6 and locally hosted secure resources 7 to 9. The secure server 13 effectively acts as a hub through which permission-based request for access to an organisation's secure resources must pass before permission to read/edit/delete etc the particular secure resource is granted or denied.

Each time a customer/staff member of a company wishes to access a secure resource 4 to 9 (such as, for example, a restricted access URL) to do something that requires a certain level of permission, an identification and authentication procedure is conducted.

The system 1 does not inherently limit the number of new users that can be issued permission rights. The system 1 also allows a first user to provide a second user with a smart card or logon identification code which allows that second user access rights to the secure system which are equivalent to the first user. The system is safeguarded so that a first user cannot grant permission rights that are superior to those of the first user. Some exceptions to this general rule exist. For example, in some cases, it is desirable that administrative personnel do not have permission rights to run some applications, but have the authority to create new users that do have such permission rights.

The administrator at XYZ Pty Ltd may initially wish to authorise users within XYZ Pty Ltd or within an allied company to access ABC Pty Ltd's Web application. The process of doing this is analogous. The relevant personnel at XYZ Pty Ltd logs onto the system, which identifies and checks if they authorised to encode new cards for access to ABC Pty Ltd's application, and what level of permission rights they are authorised to allow on the issue of further cards.

ABC Pty Ltd can then market itself as having all its Web security protected by the Central Authority. The Central Authority thus effectively provides a risk management facility for ABC Pty Ltd. The system 1 also stores an audit and non-repudiation trail in the system database 14. Every B2B or B2C customer of ABC Pty Ltd can be assured that the privacy and security of their information and transactions is protected by the Central Authority's risk management system, which is held remotely to ABC Pty Ltd.

ABC Pty Ltd is also assured that they can always identify a user accessing secured resources on their Web site, and that user has been given access by one entitled to do so. ABC Pty Ltd can also be assured that they have non-repudiation of transactions undertaken through their Web site.

As the security access system 1 stores all relationships between users and permission rights, ABC Pty Ltd will also have the benefit of being able view a relationship tree displaying every user of their application and information on who authorised the access for that user. Reports of variable complexity and type can be generated in relation to the various secure resources and users.

XYZ Pty Ltd also has access to view their branch of the ABC Pty Ltd permissioning tree. Administrators at both companies can manage and prune their relationship trees or branches as the need arises.

The privacy of the transmitted information is encrypted to ensure that it is secure on route to its destination. ABC Pty Ltd can also decide which parts of their application they wish to keep private from both internal and external customers.

The system 1 enables companies to allow users to access their application on a screen by screen basis. Each user can be given permission to access one particular URL and not another, and to perform one particular action at that URL and not another.

The system database 14 maintains records of the activities of developers and administrators for audit and non-repudiation purposes. This can be used to check the integrity of the application and for dispute resolution purposes.

A master wizard 27 can be used by the administrator at ABC Pty Ltd to sequentially build other wizards for master users to add, delete and determine the level of access new and existing users will have.

Access to a company's application can be from any computer 15 to 17. A session cookie 74 is downloaded onto the system for the duration of the session enabling access to the application.

The security system 1 described herein provides users with the ability to have all the administration of a permissioning system conducted at a remote and secure site, or secure server. The secure server 13 allows permissions 3 to be created and stored at its remote site.

The system 1 is particularly suitable for administering the security of a business organisation's data against abuse and inadvertent misuse by that organisation's staff, as all activities are able to be monitored by a trusted third party. The system 1 is particularly suitable for information-intensive organisations which deal in sensitive data which is required to be maintained and manipulated by a large number of staff on a regular basis for the same reason. Accordingly, the system 1 is particularly suitable for financial institutions such as banks, or other data-based organisations such as hospitals, or insurance companies.

Terminals 15 to 17 used by the organisation to administer secure information include smart card readers 18 to 20 which are able to read the contents of a smart card 22 to 24 used by relevant staff. The smart cards include a digital certificate 22 to 24 which identifies the respective staff member. The terminals and smart card readers may typically be within a single location, such as corporate headquarters, but may be just as easily be located through various offices, or off-site at, for example, a customer site. In short, terminals interfacing with the central server can be located anywhere on a network typically the Internet 10, LAN 11 and 12, or a virtual private network.

In one implementation, a staff member swipes the smart card through the reader at the start of any session, and computer software executing on the computing device records the public and private keys for use during the session. This computer software is preferably downloaded as required from the central server 13 and can thus be written, for example, as a Java• applet or application.

The system 1 enables the Central Authority to provide another business with the capability to use digital certificates (such as Identrus certificates) as a means of authenticating their users to other entities. This can be done remotely. As an example, ABC Pty Ltd can use the system to verify their identity.

Once the system 1 has confirmed the identify to ABC Pty Ltd, a digital certificate can be issued using the system, which can then identify that user to another entity with which they may wish to deal, such as XYZ Pty Ltd.

The responsibility of who within ABC Pty Ltd can perform this function rests with ABC Pty Ltd. The responsibility of the Central Authority is to be able to prove that the digital certificate was properly issued to an authorised user from the identified company, in this case ABC Pty Ltd. Effectively the Central Authority guarantees to XYZ Pty Ltd that ABC Pty Ltd is ABC Pty Ltd.

A further example of this process is to enable another organisation to issue certificates as a means of identifying themselves and other individuals. For example, the Central Authority may wish to licence out the certificate issuing process to another company once the Central Authority has checked their internal and external procedures. This proxy organisation can then issue certificates to third parties to allow those third parties to identify themselves when engaging in electronic transactions.

Once the encrypted keys have been presented to the application, a permission test is conducted at the secure server. The request is then either approved and re-routed to the requested Web site/network or transferred to an alternate Web page or screen advising that approval to enter that site was not given.

As described above, the system 1 includes the capability to allow any organisation to issue digital certificates through a standard Web browser or smart card. The system 1 includes the ability to allow individual smart cards to generate public and private key pairs through a smart card reader/writer. As described, these public and private keys form the basis of identification of users for the administration of permission rights. It is preferred that permission attached to the first smart card issued to an organisation includes the capability to create further smart cards with varying permission profiles.

Thus the system 1 enables an organisation to manage and maintain its own permissioning structures 2. The encoding of each card issued by the organisation occurs at its discretion. The organisation will keep a track of the permissioning structure with the aid of software tool or wizard down to an individual level.

The system 1 also has the ability to customise the page depending on how a user wishes it to look. This information on how the smart card user wishes to view the page and what they view is also stored on the secure server and activated on initial logon. Upon gaining permission to view the site, the smart card communicates with the site and dictates how it should be viewed.

This feature enables the user to determine what information they need and makes the downloading of superfluous information unnecessary. This allows the browsing experience to be speeding up the process for the user.

The system 1 is designed to provide security and access to an organisation's applications. The system uses a variety of techniques to manage restricted access to these applications and resources.

It will be understood that the invention disclosed and defined in this specification extends to all alternative combinations of two or more of the individual features mentioned or evident from the text or drawings. All of these different combinations constitute various alternative aspects of the invention.

1. A method of managing access to secure resources, the method including:
providing an schema of rights in respect of secure resources; and,
delegating to one or more users an ability to delegate a profile of selected rights in respect of one or more individual secure resources.

2. A method according to claim 1, wherein each of the profiles of rights is centrally maintained in a central server.

3. A method according to claim 2, wherein each of the profiles of rights constitutes one of the secure resources.

4. A method according to claim 2, wherein one or more of the secure resources are hosted remotely from the central server.

5. A method according to claim 4, wherein a plurality of the secure resources are hosted in, and are individually accessible within, a same server.

6. A method according to any one of the preceding claims, wherein the rights include permission rights in respect of one or more secure resources.

7. A method according to claim 6, wherein the schema of permission rights is a logical arrangement of different permission rights that have an implied hierarchical order.

8. A method according to either one of claims 6 or 7, wherein the schema is extendable to allow the grant of permissions in relation to the secure resources.

9. A method according to any one of the preceding claims, wherein the secure resources include information sources or applications.

10. A method according to any one of the preceding claims, wherein the rights include delegation rights in respect of one or more of the secure resources.

11. A method according to claim 10, wherein at least a first of the users is able to delegate to another user a profile of selected permission rights which is less than or equal to the permission rights held by the first user.

12. A method according to claim 10, wherein at least a first of the users is able to delegate to another user a profile of selected permission rights in respect of one or more secure resources to which the first user does not have access.

13. A method according to any one of the preceding claims, wherein the central server acts to grant or deny requests made by the user in respect of said secure resources.

14. A method according to any one of the preceding claims, wherein activities of the users are centrally audited and tracked in the central server.

15. A method according to any one of the preceding claims, wherein requests to the central server are referred by servers that receive requests from remote users.

16. A method according to any of the preceding claims when dependent on claim 6, wherein each of said profiles of selected permission rights represents a profile in respect of a particular set of one or more secure resources.

17. A method according to any one of the preceding claims when dependent on claim 6, wherein the permission rights govern access to generally restricted information or use of generally restricted functionality.

18. A method according to any one of the preceding claims, wherein the secure resources are information-based or functionality-based resources, access to which is generally restricted subject to verification of access rights in respect of said resources.

19. A method of allowing a secure access to a remote system via a network, the method including:
(a) storing in a central server a database of permission rights for a plurality of secure resources hosted at one or more remote servers;
(b) receiving an access request for access to one of the secure resources from one of the plurality of remote servers,
(c) establishing the identity of a user making the access request;
(d) determining whether the user has permission rights which are sufficient to allow the user to access the one secure resource; and
(e) approving or declining the access request if the permission rights of the user are or are not sufficient to allow the user to access the one secure resource.

20. A method according to claim 19, wherein the request is made to one of the remote servers and is redirected from that remote server to the central server.

21. A method of allowing secure access to a remote system via a network, the method including:
(a) receiving a request for access to a secure resource;
(b) establishing the identity of a user making said access request;
(c) determining whether the user has permission rights which are sufficient to allow the user to access the secure resource; and
of (d) approving or declining said access request if the permission rights of the user are or are not sufficient to allow the user to access the secure resource;
wherein the secure resource is hosted at a remote server, and requests for access to the secure resource are received at the remote server and redirected to a central server.

22. A method according to claim 21 wherein, upon approval of the access request, a second remote server directs the access request to a first remote server, and the first remote server responds to the user.

23. A method according to either one of claims 21 or 22, wherein establishing the identity of the user involves the use of identification codes.

24. A method according to claim 23, wherein the identification codes comprise digital certificates.

25. A method according to claim 24, wherein the digital certifications use public key cryptography techniques.

26. A method according to any one of claims 21 to 25, wherein one or more of the users with appropriate permission rights can issue identification codes for other users.

27. A method according to claim 26, wherein said one or more of the users can specify the permission rights of the other users to whom identification codes are issued.

28. A method according to any one of claims 21 to 27, wherein the secure resources are formatted in a manner specific to the user making the access request.

29. A method according to any one of the preceding claims, and further including using a software tool or wizard to develop and manage the permission rights.

30. A method according to any one of the preceding claims, and further including delegating to one or more of the users the capability to issue digital identification certificates to other users.

31. A method according to claim 30, wherein the digital identification certificates include Identrus certificates.

32. A method according to either one of claims 30 or 31, wherein the secure server operates at a remote site and uses the digital certificates stored on a smart card to verify the permission rights of a third party.

33. A method according to any one of the preceding claims, and further including downloading a software application or component onto a user's computer for the purpose of encoding a smart card with a public key and a private key.

34. A method according to claim 33, wherein the permission rights are managed by an administrator with the appropriate permission level to grant appropriate access rights to users'smart cards.
